(19) United States
(12) Patent Application Publication
(10) Pub. No.: US 2019/0071819 A1
(43) Pub. Date: Mar. 7, 2019

(54) FIBER COMPOSITE, POROUS STRUCTURE, AND NONWOVEN FABRIC

(71) Applicant: FUJIFILM Corporation, Tokyo (JP)

(72) Inventors: Kuniyuki KAMINAGA, Ashigarakami-gun (JP); Ryuta TAKEGAMI, Ashigarakami-gun (JP); Yukihiro KATAI, Ashigarakami-gun (JP); Kosuke TANIGUCHI, Ashigarakami-gun (JP); Kazunori TAKAHASHI, Ashigarakami-gun (JP)

(73) Assignee: FUJIFILM Corporation, Tokyo (JP)

(21) Appl. No.: 16/178,720

(22) Filed: Nov. 2, 2018

Related U.S. Application Data
(63) Continuation of application No. PCT/JP2017/019349, filed on May 24, 2017.

(30) Foreign Application Priority Data
Jun. 30, 2016 (JP) 2016-130196

(51) Int. Cl. D06M 11/83; D06M 11/74

(52) U.S. Cl. CPC D06M 11/83; B32B 5/022; D06M 11/74

(57) ABSTRACT

A fiber composite includes a cellulose fiber and a metal, in which the cellulose fiber contains a cellulose acylate, at least a part of a surface of the cellulose fiber carries at least a part of the metal, a degree of crystallinity of the cellulose fiber is from 0% to 50%, an average fiber diameter of the cellulose fiber is from 1 nm to 1μm and an average fiber length of the cellulose fiber is from 1 mm to 1 m.

### CROSS-REFERENCE TO RELATED APPLICATIONS

This application is a Continuation of PCT International Application No. PCT/JP2017/19349, filed on May 24, 2017, which claims priority under 35 U.S.C. § 119(a) to Japanese Patent Application No. 2016-130196, filed on Jun. 30, 2016. Each of the above application(s) is hereby expressly incorporated by reference, in its entirety, into the present application.

### BACKGROUND OF THE INVENTION

### 1. Field of the Invention

The present invention relates to a fiber composite, and a porous structure and a nonwoven fabric which are formed of the fiber composite. 2. Description of the Related Art

Nanofibers, that is, fibers having a diameter in the order of nanometers, such as several nanometers or larger and smaller than 1,000 nm, are utilized as materials for manufactured products such as biofilters, sensors, fuel cell electrode materials, precision filters, and electronic paper. Thus, development of use applications in various fields such as engineering and medicine is in active progress.

For example, in JP2009-291754A, “a harmful substance removal material which consists of a carrier constituted of fibers, in which the fiber diameter is from 10 nm to 1 μm, and the pore diameter of the carrier is from 100 μm to 1 mm” is described ([Claim 1]), and a fiber containing a cellulose ester as a main component is described as the fiber that constitutes the carrier ([Claim 3]).

### SUMMARY OF THE INVENTION

The inventors of the present invention have made attempts to use the harmful substance removal material described in W2009-291754A for a purpose in which antiviral properties are required, and have revealed that, depending on types of cellulose fibers and carriers, there is still room for improvement in antiviral properties, and there is also still room for improvement in durability when being used over a long period of time, and the like.

An object of the present invention is to provide a fiber composite having excellent antiviral properties and durability, and a porous structure and a nonwoven fabric which are formed of the fiber composite.

The inventors of the present invention conducted a thorough investigation in order to achieve the object described above, and as a result, the inventors have found that, by using a cellulose fiber of which a degree of crystallinity, an average fiber diameter, and an average fiber length are within a predetermined range as a cellulose fiber carrying a metal, both antiviral properties and durability become excellent, and therefore have completed the present invention.

That is, the inventors have found that the above-described object can be achieved by the following configuration.

[1] A fiber composite comprising a cellulose fiber; and a metal, in which the cellulose fiber contains a cellulose acylate, at least a part of a surface of the cellulose fiber carries at least a part of the metal, a degree of crystallinity of the cellulose fiber is from 0% to 50%, an average fiber diameter of the cellulose fiber is from 1 nm to 1 μm, and an average fiber length of the cellulose fiber is from 1 mm to 1 m.

[2] The fiber composite according to [1], in which the degree of crystallinity of the cellulose fiber is from 0% to 30%.

[3] The fiber composite according to [1]or [2], in which a degree of substitution of the cellulose acylate satisfies Formula (1).

2.00≤Degree of substitution ≤2.95 (1)

[4] The fiber composite according to any one of [1] to [3], in which an acyl group in the cellulose acylate is an acetyl group.

[5] The fiber composite according to any one of [1] to [4], in which a content of the metal s from 0.001 times to 10 times the cellulose fiber on a mass basis.

[6] The fiber composite according to any one of [1] to [5], in which the metal is a metal particle.

[7] The fiber composite according to [6], in which an average particle diameter of the metal article is from 1 nm to 2 μm.

[8] The fiber composite according to any one of [1] to [7], in which the metal is at least one selected from the group consisting of silver, copper, zinc, iron, lead, bismuth, and calcium.

[9] A porous structure comprising the fiber composite according to any one of [1] to [8].

[10] The porous structure according to [9], in which a void volume is from 30% to 95%.

[11] The porous structure according to [9] or [10 ], in which a through-hole is provided, and an average hole diameter of the through-hole is from 0.01 μm to 10 μm.

[12] A nonwoven fabric comprising the fiber composite according to any one of [1] to [8].

According to the present invention, it is possible to provide the fiber composite having excellent antiviral properties and durability, and the porous structure and the nonwoven fabric which are formed of the fiber composite.

### DESCRIPTION OF THE PREFERRED EMBODIMENTS

Hereinafter, the invention will be described in detail.

The explanation of the configuration requirements described below is based on representative embodiments of the present invention; however, the invention is not limited to such embodiments.

According to the present specification, a numerical value range indicated using “to” means a range including the numerical values described before and after “to” as a lower limit value and an upper limit value.

[Fiber Composite]

A fiber composite of the embodiment of the invention is a fiber composite having a cellulose fiber and a metal, in which at least a part of a surface of the cellulose fiber carries at least a part of the metal.

In addition, in the fiber composite of the embodiment of the invention, a degree of crystallinity of the cellulose fiber is from 0% to 50%, an average fiber diameter of the cellulose fiber is from 1 nm to 1 μm, and an average fiber length of the cellulose fiber is from 1 mm to 1 m.

<Degree of Crystallinity>

In the present specification, the degree of crystallinity means a value measured by a wide angle X-ray diffraction measurement as below.

First, a measurement of the surface of the fiber composite is performed from 2θ=5° to 40° with a step of 0.05°.

Next, based on measured profile, peaks of an amorphous halo and crystal diffraction are subjected to waveform separation, and the degree of crystallinity (%) is calculated by Formula (I) from a peak intensity A of the amorphous halo and a maximum peak intensity B of the crystal diffraction after the waveform separation.

Degree of crystallinity (%)=(peak intensity A/peak intensity B)×100 (I)

<Average Fiber Diameter>

In the present specification, the average fiber diameter means a value measured by as below.

A surface of the fiber composite is observed by taking a Transmission Electron Microscope (TEM) image or a Scanning Electron Microscope (SEM) image.

An observation based on the electron microscopic image is performed at a magnification ratio selected from 1,000 times to 5,000 times depending on a size of a constituent fiber. However, a sample, observation conditions, and a magnification ratio are adjusted so as to satisfy the following conditions.

(1) One straight line X is drawn at an arbitrary site within an image to be observed, and 20 or more fibers intersect this straight line X.

(2) A straight line Y perpendicularly intersecting the straight line X is drawn in the same image, and 20 or more fibers intersect the straight line Y.

In regard to the electron microscopic observation images such as described above, for each of the fibers intersecting the straight line X and the fibers intersecting the straight line Y, widths (minor axis of the fiber) of at least 20 fibers (that is, at least 40 fibers in total) are read out. In this manner, an observation of at least 3 sets or more of the electron microscopic images such as described above is made, and fiber diameters of at least 40 fibers×3 sets (that is, at least 120 fibers) are read out.

The average fiber diameter is determined by averaging the fiber diameters read out as such.

<Average Fiber Length>

In the present specification, the average fiber length of the cellulose fiber means a value measured by as below.

That is, the fiber length of the cellulose fiber can be determined by analyzing the electron microscopic observation image used on the occasion of measuring the average fiber diameter described above.

Specifically, in the electron microscopic observation image such as described above, for each of the fibers intersecting the straight line X and the fibers intersecting the straight line Y, fiber lengths of at least 20 fibers (that is, at least 40 fibers in total) are read out.

In this manner, an observation of at least 3 sets or more of the electron microscopic images such as described above is made, and the fiber lengths of at least 40 fibers×3 sets (that is, at least 120 fibers) are read out.

The average fiber length is determined by averaging the fiber lengths read out as such.

The fiber composite of the embodiment of the invention uses the fiber of which the degree of crystallinity is from 0% to 50%, the average fiber diameter is from 1 nm to 1 μm, the average fiber length is from 1 mm to 1 m as the cellulose fiber carrying the metal, and thus is excellent in both antiviral properties and durability, as described above.

The reason why such effects are exhibited is not clearly known in detail; however, the inventors of the present invention speculate the reason as follows.

That is, by using the cellulose fiber of which the average fiber diameter and the average fiber length are within the above-described range, a surface area of the cellulose fiber in the fiber composite becomes large, and an appropriate amount of voids and a network structure are generated near the surface. It is considered that, with such a structure, the cellulose fiber can homogeneously carry a sufficient amount of metals, and as a result, frequency of virus collisions becomes high, and therefore the antiviral properties are improved.

In addition, with the cellulose fiber of which the degree of crystallinity is from 0% to 50%, it is considered that interactions working between molecules of cellulose (or derivatives thereof) molecules constituting the cellulose fiber are weak to some extent, and for this reason, it is considered that affinity of the cellulose molecules for the metal becomes high, and therefore the durability is improved.

Hereinafter, the cellulose fiber and the metal included in the fiber composite of the embodiment of the invention will be described in detail.

[Cellulose Fiber]

In the present specification, the cellulose fiber means a single fiber containing cellulose or a derivative thereof, or an aggregation consisting of a plurality of these fibers.

The degree of crystallinity of the cellulose fiber is preferably 0% or higher and 30% or lower, and more preferably 1% or higher and 25% or lower, for the reason that the durability is further improved.

The degree of crystallinity of the cellulose fiber can be adjusted by heating a produced fiber composite, or a structure consisting of the cellulose fiber before allowing the cellulose fiber to carry the metal (for example, cellulose nanofibers, nonwoven fabrics, and the like), and can be appropriately adjusted by changing a heating temperature and a heating time.

For the reason that the fiber has high mechanical strength and the nonwoven fabric can be produced easily, the average fiber diameter of the cellulose fiber is preferably from 50 nm to 1 μm, and more preferably from 100 nm to 800 nm.

For the reason that fraying of the fiber is suppressed in a case in which the nonwoven fabric is formed, the average fiber length of the cellulose fiber is preferably from 1 mm to 100 mm, more preferably from 1 mm to 50 mm, even more preferably from 1 mm to 10 mm, and particularly preferably from 1 mm to 5 mm.

It is preferable that the cellulose fiber contains a cellulose acylate as a derivative of the cellulose, for the reason that the affinity for the metal becomes high, and the durability is further improved.

Here, the “cellulose acylate” refers to a cellulose ester in which some or all of the hydrogen atoms that constitute hydroxyl groups of cellulose, that is, free hydroxyl groups existing at the 2-position, 3-position, and 6-position of a β-1,4-bonded glucose unit, have been substituted by acyl groups.

In regard to the degree of substitution of the cellulose acylate, for the reason that interactions with the metal becomes strong and the durability is further improved, it is preferable that Formula (1) is satisfied.

In the present specification, the “degree of substitution” means to the degree of substitution of the hydrogen atoms that constitute hydroxyl groups of cellulose by acyl groups (hereinafter will also be referred to as “acylation degree”), and the degree of substitution can be calculated by comparing the area intensity ratio of carbon atoms of cellulose acylate measured by a ¹³C-NMR method.

2.00≤Degree of substitution 2.95 (1)

<Substituent (Acyl Group)>

Specific examples of the acyl group include an ace group, a propionyl group, a butyryl group, and the like.

The acyl groups to be substituted may be composed only of a single kind (for example, only an acetyl group) or may be of two or more kinds.

The acyl group in the cellulose acylate is preferably an acetyl group for the reason that the uniformity of the fiber diameter is further enhanced and a more satisfactory external appearance is obtained in a case in which the nonwoven fabric is produced.

The cellulose acylate in which the acyl group is the acetyl group will also be referred to as “cellulose acetate” in the following explanation.

<Degree of Substitution (Acylation Degree)>

The degree of substitution of the acyl group is more preferably 2.10 to 2.95, and even more preferably 2.30 to 2.95 for the reason that the uniformity of the fiber diameter is further enhanced and a more satisfactory external appearance is obtained in a case in which the nonwoven fabric is produced.

The degree of substitution of the acyl group can be appropriately adjusted by various methods, and examples of the methods include a method in which a partial hydrolysis time is changed when synthesizing the cellulose acylate, a method in which alkaline saponification is performed after producing the nonwoven fabric, and the like.

<Molecular Weight>

A number average molecular weight (Mn) of the cellulose acylate is not particularly limited; however, from the viewpoint of the mechanical strength of the fiber composite, the number average molecular weight is preferably 40,000 or more, more preferably 40,000 to 150,000, and even more preferably 60,000 to 100,000.

In addition, a weight-average molecular weight (Mw) of the cellulose acylate is not particularly limited; however, from the viewpoint of the mechanical strength of the fiber composite, the weight-average molecular weight is preferably 100,000 or more, more preferably 100,000 to 500,000, and even more preferably 150,000 to 300,000.

The weight-average molecular weight or number average molecular weight according to the present specification means a value measured by a gel permeation chromatography (GPC) method under the following conditions.

Apparatus name: HLC-8220 GPC (Tosoh Corporation)

Type of column: TSK gel Super HZ4000 and HZ2000 (Tosoh Corporation)

Fluent: Dimethylformamide (DMF)

Flow rate: 1 ml/min

Detector: RI

Sample concentration: 0.5%

Calibration curve base resin: TSK standard polystyrene (molecular weights 1,050, 5,970, 18,100, 37,900, 190,000, and 706,000)

<Method for Synthesizing Cellulose Acylate>

Regarding a method for synthesizing the cellulose acylate as described above, the description in p. 7 to 12 of Hatsumei Suishin Kyokai Kokai Giho (Journal of Technical Disclosure) (Technology No. 2001-1745, published on Mar. 15, 2001. Japan Institute for Promoting Invention and Innovation) is also applicable.

(Raw Material)

Regarding a raw material of cellulose, suitable examples include raw materials originating from hardwood pulp, softwood pulp, cotton linter, and the like. Among them, raw materials originating from cotton linter are preferred because an amount of hemicellulose is small, and a nanofiber having further enhanced uniformity of the fiber diameter can be produced.

(Activation)

It is preferable that the raw material of cellulose is subjected to a treatment of contacting with an activating agent (activation), prior to acylation.

Specific examples of the activating agent include acetic acid, propionic acid, butyric acid, and the like, and among them, acetic acid is preferred.

An amount of addition of the activating agent is preferably 5% by mass to 10,000% by mass, more preferably 10% by mass to 2,000% by mass, and even more preferably 30% by mass to 1,000% by mass with respect to the raw material of cellulose.

A method for addition can be selected from methods such as spraying, dropwise addition, and immersion.

An activation time is preferably 20 minutes to 72 hours, and more preferably 20 minutes to 12 hours.

An activation temperature is preferably 0° C. to 90° C., and more preferably 20° C. to 60° C.

Furthermore, an acylation catalyst such as sulfuric acid may be added to the activating agent, in an amount of 0.1% to 30% by mass with respect to the activating agent.

In terms of synthesizing a uniform cellulose acylate, the hydroxyl groups of cellulose is acylated preferably by a method of reacting cellulose with an acid anhydride of a carboxylic acid using Bronsted acid or a Lewis acid (see “Rikagaku Shoten (Dictionary of Physics and Chemistry)”, 5^{th} Edition (2000)) as a catalyst, and control of the molecular weight is also enabled by this reaction method.

Examples of the method for obtaining the cellulose acylate include a method of causing a reaction by adding two kinds of carboxylic acid anhydrides as acylating agents as a mixture or in sequence to the system; a method of using a mixed acid anhydride of two kinds of carboxylic acids (for example, a mixed acid anhydride of acetic acid and propionic acid); a method of forming a mixed acid anhydride (for example, a mixed acid anhydride of acetic acid and propionic acid) within the reaction system by using acid anhydrides of a carboxylic acid and another carboxylic acid (for example, acid anhydrides of acetic acid and propionic acid) as raw materials, and reacting the mixed acid anhydride with cellulose; a method of first synthesizing a cellulose acylate having a degree of substitution of less than 3, and further acylating residual hydroxyl groups by using an acid anhydride or an acid halide; and the like.

Furthermore, in regard to the synthesis of a cellulose acylate having a high degree of the 6-position substitution, the details are described in JP1999-005851A (JP-H11-005851A), JP2002-212338A, JP2002-338601A, and the like.

<Acid Anhydride>

The acid anhydride of a carboxylic acid is preferably an acid anhydride of a carboxylic acid having 2 to 6 carbon atoms, and specifically, suitable examples include acetic anhydride, propionic anhydride, butyric anhydride, and the like.

It is preferable that the acid anhydride is added in an amount of 1.1 to 50 equivalents, more preferably 1.2. to 30 equivalents, and even more preferably 1.5 to 10 equivalents, with respect to the hydroxyl groups of cellulose.

<Catalyst>

Regarding the acylation catalyst, it is preferable to use a Bronsted acid or a Lewis acid, and it is more preferable to use sulfuric acid or perchloric acid.

An amount of addition of the acylation catalyst is preferably 0.1% to 30% by mass, more preferably 1% to 15% by mass, and even more preferably 3% to 12% by mass with respect to the activating agent.

<Solvent>

Regarding the acylation solvent, it is preferable to use a carboxylic acid, and it is more preferable to use a carboxylic acid having from 2 to 7 carbon atoms. Specifically, it is even more preferable to use, for example, acetic acid, propionic acid, butyric acid, or the like. These solvents may also be used as mixtures.

<Condition>

In order to control a temperature increase caused by the heat of reaction of acylation, it is preferable that the acylating agent is cooled in advance.

An acylation temperature is preferably −50° C. to 50° C., more preferably −30° C. to 40° C., and even more preferably −20° C. to 35° C.

A minimum temperature of the reaction is preferably −50° C. or higher, more preferably −30° C. or higher, and even more preferably −20° C. or higher.

An acylation time is preferably 0.5 hours to 24 hours, more preferably 1 hour to 12 hours, and even more preferably 1.5 hours to 10 hours.

Adjustment of the molecular weight is enabled by controlling the acylation time.

<Reaction Terminating Agent>

It is preferable that a reaction terminating agent is added after the acylation reaction.

The reaction terminating agent may be any compound capable of decomposing an acid anhydride, and specific examples thereof include water, an alcohol having 1 to 3 carbon atoms, and a carboxylic acid (for example, acetic acid, propionic acid, butyric acid, or the like). Above all, a mixture of water and a carboxylic acid (acetic acid) is preferred.

A composition of water and the carboxylic acid is such that a content of water is preferably 5% to 80% by mass, more preferably 10% to 60% by mass, and even more preferably 15% to 50% by mass.

<Neutralizing Agent>

After termination of the acylation reaction, a neutralizing agent may be added.

Examples of the neutralizing agent include ammonium, organic quaternary ammoniums, alkali metals, metals of Group 2, metals of Groups 3 to 12, carbonates, hydrogen carbonates, organic acid salts, hydroxides, or oxides of the elements of Groups 13 to 15, and the like. Specifically, suitable examples include carbonate, hydrogen carbonate, acetate, or hydroxide of sodium, potassium, magnesium, or calcium.

<Partial Hydrolysis>

The cellulose acylate obtained by the acylation described above has a total degree of substitution of almost 3; however, for the purpose of adjusting the degree of substitution to a desired value (for example, degree of about 2.8), the degree of acyl substitution of the cellulose acylate can be decreased to a desired extent, by partially hydrolyzing ester bonds by maintaining the cellulose acylate for several minutes to several days at 20° C. to 90° C. in the presence of water and a small amount of catalyst (for example, an acylation catalyst such as residual sulfuric acid). Meanwhile, partial hydrolysis can be terminated as appropriate using residual catalyst and the neutralizing agent.

<Filtration>

Filtration may be carried out in any step between the completion of acylation and reprecipitation. It is also preferable to dilute the system with an appropriate solvent prior to filtration.

<Reprecipitation>

A cellulose acylate solution can be mixed with water or an aqueous solution of a carboxylic acid (for example, acetic acid, propionic acid, or the like), and thus reprecipitation can be induced. Reprecipitation may be any of continuous type or batch type.

<Washing>

After reprecipitation, it is preferable to perform a washing treatment. Washing is carried out using water or warm water, and completion of washing can be checked through the pH, ion concentration, electrical conductivity, elemental analysis, or the like.

<Stabilization>

It is preferable that a weak alkali (carbonate, hydrogen carbonate, hydroxide, or oxide of Na, K, Ca, Mg, or the like) is added to the cellulose acylate obtained after washing, for the purpose of stabilization.

<Drying>

It is preferable that the cellulose acylate is dried at 50° C. to 160° C. until a moisture content reaches 2% by mass or less.

[Metal]

In the fiber composite of the embodiment of the invention, at least a part of the surface of the cellulose fiber described above carries at least a part of the metal.

Herein, the metal may be carried by the entire surface of the cellulose fiber, or may be carried within the aggregation of the plurality of cellulose fibers, as long as the metal is carried by at least the part of the surface of the cellulose fiber.

In the present specification, the term “carrying” means a state in which the metal is chemically, physically, or electrically bonded or adsorbed to at least the part of the surface of the cellulose fiber.

Specific examples of the metal include silver, copper, zinc, iron, lead, bismuth, calcium, and the like, and one of these metals may be used alone, or two or more kinds thereof may be used in combination.

Among them, silver, copper, zinc, and calcium are preferable, and silver and copper are more preferable.

The metal may be carried in a state of a metal compound (for example, copper oxide, calcium carbonate, and the like) containing the above-described metals.

A shape of the metal is not particularly limited. For example, the shape may be any of particulate, tabular, or rodlike shapes, but is preferably the particulate shape, that is, the metal being metal particles for the reason that a surface area and a carried amount of the metal can be increased at the same time, and an effect of action of the metal, that is, further improvement in the antiviral properties.

The metal particles are preferably used as a metal particle dispersion in which the metal particles are dispersed in a solvent from the viewpoint of workability of allowing the surface of the cellulose fiber to carry the metal as described above.

The solvent is not particularly limited as long as it is a solvent capable of dispersing the metal particles and of wettedly spreading on the surface of the cellulose fiber described above, and for example, an organic solvent such as water, alcohols, ethers, and esters can be widely used.

The metal particle dispersion may contain a dispersing agent. Examples of the dispersing agent include a low molecular-type dispersing agent such as alkyl amines, alkanethiols, and alkanediols, a polymer-type dispersing agent having various functional groups, and the like.

For the reason that the durability is further improved, an average particle diameter of the metal particles is preferably from 1 nm to 2 μm, more preferably from 1 nm to 1 μm, even more preferably from 1 nm to 500 nm, and particularly preferably from 1 nm to 300 nm.

In the present specification, the average particle diameter of the metal particles is intended to be an average secondary particle diameter, and refers to an average particle diameter of all of metal particles including primary particles which are present in the metal particle dispersion and are not linked to each other.

The secondary particle diameter is determined by measuring a number average particle diameter using the metal particle dispersion, with a dynamic light scattering method (for example, light scattering measurement device of Malvern Panalytical Ltd (ZETASIZER ZS)).

For the reason that agglomeration of the metal particles is prevented, and the surface of the metal particle is easily exposed to the surface of the cellulose fiber, a content of the metal is preferably from 0.001 times to 10 times, more preferably from 0.001 times to 5 times, even more preferably from 0.001 times to 2 times, most preferably from 0.002 times to 1 time, and particularly preferably from 0.002 times to less than 1 time the above-described cellulose fiber on a mass basis.

[Method for Producing Fiber Composite]

A method for producing the fiber composite of the embodiment of the invention is not particularly limited, and examples of the method include a method in which the metal is carried by a surface of a structure after producing the structure (for example, nanofibers, nonwoven fabrics, and the like) consisting of the cellulose fiber of which the degree of crystallinity is from 0% to 50%, the average fiber diameter is from 1 nm to 1 μm, and the average fiber length is from 1 mm to 1 m.

<Nanofiber and Nonwoven Fabric>

A method for producing the nanofiber is not particularly limited; however, a production method utilizing an electrospinning method (hereinafter will also be referred to as “electrospinning method”) is preferable, and the nanofiber can be produced by, for example, discharging a solution (hereinafter will also be referred to as spinning solution) obtained by dissolving the above-described cellulose acylate in a solvent, from a distal end of a nozzle at a constant temperature in the range of from 5° C. to 40° C., applying a voltage between the solution and a collector, and jetting out fibers from the solution into the collector. Specifically, the nanofiber can be produced by a method shown in paragraphs <0014> to <0044> and FIGS. 1 and 2 of JP2016-053232A, and the like.

In addition, a method for producing the nonwoven fabric is not limited, and a nonwoven fabric 120 can be produced by a nanofiber producing apparatus 110 shown in FIG. 1 of JP2016-053232A, for example.

<Carrying of Metal>

A method for allowing the surface of the structure to carry the metal is not particularly limited, and examples of the method include a method of applying the above-described metal particle dispersion onto the surface of the structure, a method of immersing the structure into the above-described metal particle dispersion, and the like.

[Porous Structure]

The porous structure of the embodiment of the invention is a porous structure having the above-described fiber composite of the embodiment of the invention.

The porous structure of the embodiment of the invention may be in an aspect using only the fiber composite as long as the fiber composite is self-supported therein, but the porous structure may be in an aspect in which the fiber composite is provided on a substrate, irrespective of whether the fiber composite is self-supported or not.

As the substrate, a sheet, a plate, or a cylindrical body can be used.

As a material of the substrate, a resin or a metal is used, and a resin is preferable from the viewpoint of more easily forming a film.

In addition, a surface of the substrate may be hydrophobic or hydrophilic.

Specific examples of a resin substrate include polytetrafluoroethylene, polyethylene, polypropylene, polyethylene terephthalate, polyvinyl chloride, polyvinylidene chloride, polystyrene, acrylic resin, and the like.

Specific examples of a metal substrate include aluminum, stainless steel, zinc, iron, brass, and the like.

The porous structure of the embodiment of the invention can carry large amounts of metal, and a void volume therein is preferably from 30% to 95%, and more preferably from 35% to 90%, for the reason that the antiviral properties are further improved.

In the present specification, the void volume of the porous structure means a value calculated by Formula.

Void volume (%)=[1-{m/p/(S×d)}]×100

m: Sheet weight (g)

p: Resin density (g/cm³)

5: Sheet area (cm²)

d: Sheet thickness (cm)

In addition, the porous structure of the embodiment of the invention may have a through-hole.

In a case where the porous structure has the through-hole, an average hole diameter of the through-hole is preferably from 0.01 μm to 10 μm, more preferably from 0.1 μm to 10 μm, even more preferably from 0.2 μm to 8 μm, and particularly preferably from 0.2 μm to 6 μm, for the reason that strength is increased, and control of a hole diameter of the through-hole becomes simple.

Herein, the average hole diameter can be evaluated by increasing air pressure to 5 cc/min with respect to a sample completely wetted by GALWICK (manufactured by Porous Materials Inc.) in a pore size distribution measurement test using a perm porometer (CFE-1200 AEX manufactured by Seika Corporation), in the same manner as in the method described in paragraph <0093> of JP2012-046843A.

[Nonwoven Fabric]

The nonwoven fabric of the embodiment of the invention is a nonwoven fabric constituting of the above-described fiber composite of the embodiment of the invention.

The nonwoven fabric of the embodiment of the invention can be used for applications such as medical equipment, batteries (for example, a secondary battery separator, a secondary battery electrode, and the like), building materials (for example, a heal insulating material, a sound absorbing material, and the like), a curtain, a heat-resistant bag filter, and a filter cloth.

For example, in the case of the heat-resistant bag filter, the nonwoven fabric can be used as a bag filter for use in general garbage incinerators and industrial waste incinerators.

In the case of the secondary battery separator, the nonwoven fabric can he used as a separator for use in lithium ion secondary batteries.

In the case of the secondary battery electrode, with use of a deposit of a thermosetting nanofiber before thermosetting, the nonwoven fabric can be used as a binder for forming a secondary battery electrode. Furthermore, an electrically conductive nonwoven fabric obtained by dispersing and mixing a powder electrode material into the spinning solution described above, electrospinning the mixture, and thermosetting a deposit obtained therefrom, can also be used as a secondary battery electrode.

In the case of the heat insulating material, the nonwoven fabric can be used for a backup material for refractory bricks, or a combustion gas seal.

In the case of the filter cloth, the nonwoven fabric can be used as a filter cloth for microfilter, or the like by adjusting a thickness and the like of the nonwoven fabric as appropriate, and adjusting a pore size of the nonwoven fabric. By using the filter cloth, solid components in a fluid such as a liquid or a gas can be separated.

In the case of the sound absorbing material, the nonwoven fabric can be used as a sound absorbing material such as a wall surface sound insulation reinforcement or an inner wall sound absorbing layer.

### EXAMPLE

Hereinafter, the present invention will be described in more detail based on Examples. The materials, amounts used, proportions, treatment details, treatment procedures, and the like disclosed in the following Examples can be modified as appropriate as long as the gist of the invention is maintained. Therefore, the scope of the invention should not be limitedly interpreted by the Examples described below.

### Example 1

<Synthesis of Cellulose Acetate>

Cellulose (raw material: cotton linter) was mixed with acetate and sulfuric acid, and the mixture was acetylated while a reaction temperature was maintained at 40° C. or lower.

After the raw material cellulose disappeared and acetylation was completed, the system was further heated continuously at a temperature of 40° C. or lower, and the degree of polymerization was adjusted to a desired value.

Next, residual acid anhydride was hydrolyzed by adding an aqueous solution of acetic acid, and then partial hydrolysis was performed by heating at a temperature of 60° C. or lower. Thus, the degree of substitution was adjusted as shown in Table 1.

Residual sulfuric acid was neutralized with an excess amount of magnesium acetate. Reprecipitation from the aqueous solution of acetic acid was performed, and washing with water was repeated. Thus, a cellulose acetate was synthesized.

<Production of Cellulose Fiber>

The cellulose acetate thus synthesized was dissolved in a mixed solvent of 91% of dichloromethane and 9% of N-methyl-2-pyrrolidone (NMP) to prepare a cellulose acetate solution having a concentration of 4 g/100 cm³, and therefore a cellulose fiber (nonwoven fabric) having a size of 20 cm×30 cm, which was formed from cellulose acetate nanofibers, was produced using a nanofiber producing apparatus.

<Adjustment of Degree of Crystallinity>

The cellulose fiber thus produced was heated at 200° C. for 1 minute, and the degree of crystallinity was adjusted.

When the degree of crystallinity was measured by the above-described method, the degree of crystallinity of the cellulose fiber after heating was 6%.

<Metal Particle Dispersion>

A method described in paragraphs <0048> to <0050> of JP2015-048494A and Conditions described in paragraphs <0012> to <0035> of JP2015-048494A were adopted, and therefore a metal particle dispersion containing copper particles was prepared. When an average particle diameter (average secondary particle diameter) of the metal particles was measured by the above-described method, the average particle diameter of the copper particles was 18 nm.

<Production of Fiber Composite>

The cellulose fiber of which the degree of crystallinity was adjusted was cut into a square (10 cm×10 cm).

A spray container was filled with the metal particle dispersion produced in advance, and the dispersion was sprayed so that a mass of the metal becomes 0.005 times a mass of the cut cellulose fiber.

Next, the cut cellulose fiber was hung so that the fiber was not folded or loosened, and was dried under environments of 30° C. and 40% relative humidity, and therefore a fiber composite carrying the metal was produced.

When a surface of the fiber composite thus produced was observed by SEM, it could be checked that the metal is attached to the surface of the cellulose fiber.

### Example 2

A fiber composite was produced in the same method as in Example 1 except that a partial hydrolysis time was changed to adjust the degree of substitution by an acetyl group to a value shown in Table 1, a heating time of the cellulose fiber was changed to adjust the degree of crystallinity to a value shown in Table 1, and spraying was performed so that the mass of the metal became a value shown in Table 1 with respect to the mass of the cut cellulose fiber.

### Example 3

A fiber composite was produced in the same method as in Example 1 except that the partial hydrolysis time was changed to adjust the degree of substitution by an acetyl group to a value shown in Table 1, the heating time of the cellulose fiber was changed to adjust the degree of crystallinity to a value shown in Table 1 by using a cellulose acetate solution of 4.5 g/100 cm³ at the time of producing the cellulose fiber, and spraying was performed so that the mass of the metal became a value shown in Table 1 with respect to the mass of the cut cellulose fiber by using a dispersion of fatty acid silver salt particles B (average particle diameter: 120 nm) described in paragraphs <0190> to <0194> of JP1999-349325A (JP-H11-349325A).

### Example 4

A fiber composite was produced in the same method as in Example 1 except that a partial hydrolysis time was changed to adjust the degree of substitution by an acetyl group to a value shown in Table 1, a heating time of the cellulose fiber was changed to adjust the degree of crystallinity to a value shown in Table 1, and spraying was performed so that the mass of the metal became a value shown in Table 1 with respect to the mass of the cut cellulose fiber.

### Examples 5 to 7

A fiber composite was produced in the same method as in Example 3 except that the partial hydrolysis time was changed to adjust the degree of substitution by an acetyl group to a value shown in Table 1, and the heating time of the cellulose fiber was changed to adjust the degree of crystallinity to a value shown in Table 1.

### Example 8

A cellulose fiber (nonwoven fabric) formed from cellulose acetate nanofibers was produced by the same method as in Example 1.

Next, the cellulose fiber thus produced was immersed in an aqueous solution of 0.5 N sodium hydroxide to which 5% ethanol was added, for 48 hours.

Next, the fiber was washed after immersion into pure water and dried, and therefore deacylated cellulose fiber (nonwoven fabric) was produced. The degree of substitution after deacylation was 0.04 as shown in Table 1.

A fiber composite was produced in the same method as in Example 2 except that the deacylated cellulose fiber (nonwoven fabric) was used.

### Example 9

A fiber composite was produced in the same method as in Example 1 except that cellulose propionate in which the acyl group was changed from the acetyl group to a propionyl group was synthesized, and the cellulose fiber was produced using a cellulose propionate solution of 4.4 g/100 cm³.

### Example 10

A fiber composite was produced in the same method as in Example 3 except that cellulose propionate in which the acyl group was changed from the acetyl group to the propionyl group was synthesized, and the cellulose fiber was produced using a cellulose propionate solution of 4.3 g/100 cm³.

### Example 11

A fiber composite was produced in the same method as in Example 1 except that the partial hydrolysis time was changed to adjust the degree of substitution by the acetyl group to a value shown in Table 1, the heating time of the cellulose fiber was changed to adjust the degree of crystallinity to a value shown in Table 1, and spraying was performed so that the mass of the metal became a value shown in Table 1 with respect to the mass of the cut cellulose fiber.

### Example 12

A fiber composite was produced in the same method as in Example 3 except that the partial hydrolysis time was changed to adjust the degree of substitution by the acetyl group to a value shown in Table 1, and the heating time of the cellulose fiber was changed to adjust the degree of crystallinity to a value shown in Table 1.

### Example 13

A fiber composite was produced in the same method as in Example 1 except that spraying was performed so that the mass of the metal became a value shown in Table 1 with respect to the mass of the cut cellulose fiber by ⁻using a copper particle dispersion (average particle diameter: 2100 nm) prepared by a method described in paragraph <0051> of JP2015-048494A.

### Comparative Example 1

A nonwoven fabric formed from nanofibers was produced in the same method as in Example 1, except that the metal was not carried.

### Comparative Example 2

A fiber composite was produced in the same method as in Example 1 except that the partial hydrolysis time was changed to adjust the degree of substitution by the acetyl group to a value shown in Table 1, the heating time of the cellulose fiber was changed to adjust the degree of crystallinity to a value shown in Table 1, and spraying was performed so that the mass of the metal became a value shown in Table 1 with respect to the mass of the cut cellulose fiber.

### Comparative Example 3

A fiber composite was produced in the same method as in Example 3 except that a cellulose acetate solution of 8.5 g/100 cm³ was used at the time of producing the cellulose fiber.

### Comparative Example 4

A fiber composite was produced in the same method as in Example 3 except that the synthesized cellulose acetate was dissolved in a mixed solvent of 90.5% of dichloromethane and 9.5% of N-methyl-2-pyrrolidone (NMP) so as to use a cellulose acetate solution having a concentration of 5 g/100 cm³ at the time of producing the cellulose fiber.

### Comparative Example 5

20 g of softwood kraft pulp was immersed in 400 g of water and dispersed with a mixer.

0.2 g of TEMPO (2,2,6,6-tetramethyl-1-piperidinyloxy of Sigma-Aldrich) dissolved in 170 g of water in advance and 2 g of NaBr were added to the dispersed pulp slurry, and the mixture was further diluted with water so that the entire mixture became 900 mL. The inside of the system was kept at 20° C., and an aqueous solution of sodium hypochlorite was weighed so that the solution became 10 mmol with respect to 1 g of cellulose, a pH was adjusted to pH 10, and then the resultant solution was added to the system. The pH started to decrease from the start of the dropwise addition, but the pH was kept at 10 with the aqueous solution of 0.5 N sodium hydroxide using an automatic titrator. Two hours after the start of the dropwise addition, when the aqueous solution of 0.5 N sodium hydroxide reached 2.5 mmol/g, 20 g of ethanol was added to the resultant solution, and the reaction was stopped. 0.5 N Hydrochloric acid was added to the reaction system and the pH was lowered to pH 2. An oxidized pulp was filtered and repeatedly washed with 0.01 N hydrochloric acid or water, and therefore the oxidized pulp was obtained.

The oxidized pulp was diluted with water so that a concentration of solid contents became 1.0% by mass, an aqueous solution of 1 N sodium hydroxide was added to the obtained diluted solution to adjust the pH to 8, and then the mixture was treated with an ultrasound homogenizer for 30 minutes, and therefore a cellulose nanofiber dispersion was obtained. The obtained dispersion was transparent and the pH was 6.

The cellulose nanofiber dispersion obtained was poured into a petri dish and dried at 60° C. for 9 hours, and therefore a sheet was obtained.

Next, the metal particle dispersion was sprayed to the obtained sheet in the same method as in Example 1 so that the mass of the metal became 0.005 times the mass of the cut sheet.

### Comparative Example 6

A nonwoven fabric formed from nanofibers was produced in the same method as in Comparative Example 5, except that the metal was not carried.

### Comparative Example 7

A fiber composite was produced in the same method as in Example 1 except that a polyacrylonitrile fiber was produced using hydrophobic polyacrylonitrile (weight-average molecular weight: 150,000, manufactured by Sigma-Aldrich) instead of the cellulose acetate, and spraying was performed so that the mass of the metal became a value shown in Table 1 with respect to the mass of the cut polyacrylonitrile fiber.

### Comparative Example 8

A fiber composite was produced in the same method as in Example 3 except that the polyacrylonitrile fiber was produced using hydrophobic polyacrylonitrile (weight-average molecular weight: 150,000, manufactured by Sigma-Aldrich) instead of the cellulose acetate, and spraying was performed so that the mass of the metal became a value shown in Table 1 with respect to the mass of the cut polyacrylonitrile fiber.

### Comparative Example 9

A fiber composite was produced in the same method as in Example 1 except that a polyvinyl alcohol fiber was produced using hydrophilic polyvinyl alcohol (PVA 217, manufactured by Kuraray Co., Ltd.) instead of the cellulose acetate, and spraying was performed so that the mass of the metal became a value shown in Table 1 with respect to the mass of the cut polyvinyl alcohol fiber.

### Comparative Example 10

A fiber composite was produced in the same method as in Example 3 except that the polyvinyl alcohol fiber was produced using hydrophilic polyvinyl alcohol (PVA 217, manufactured by Kuraray Co., Ltd.) instead of the cellulose acetate, and spraying was performed so that the mass of the metal became a value shown in Table 1 with respect to the mass of the cut polyvinyl alcohol fiber.

[Evaluation]

<Antiviral Properties>

The evaluation was performed by a method of ISO 18184.

Influenza virus and feline calicivirus were respectively used as virus so as to perform the evaluation. The results are shown in Table 1.

<Durability>

The fiber composite thus produced was immersed in large amounts of water, and pulled up after 5 minutes, and then dried.

The amount of metal before and after the immersion was quantitatively determined by elemental analysis by Inductively Coupled Plasma (ICP)-Mass Spectrometry (MS), and a residual amount of metal particles was evaluated by the following standard. The results are shown in Table 1. In Comparative Examples 1 and 6, the metal was not carried, and therefore the evaluation on durability was not performed.

1: The residual amount is 85% or more

2: The residual amount is 60% or more and less than 85%

3: The residual amount is 35% or more and less than 60%

4: The residual amount is 10% or more and less than 35%

5: The residual amount is less than 10%

TABLE 1

| | Cellulose fiber | | | | | | | Carried metal | | | | | |
|---|---|---|---|---|---|---|---|---|---|---|---|---|---|
| | | | | | | | Average | | Mass | Aver | | | |
| | Cellulose acylate | | | Aver- | | | hole | | with | age | Evaluation | | |
| | and the like | | Degree | age | Aver- | | diameter | | respect | par- | Antiviral properties | | |
| | | Degree | of | fiber | age | Void | of | | to | ticle | Influenza | Feline | |
| | | of | crys- | diam- | fiber | vol- | through- | | mass | diam- | virus | calicivirus | |
| | | substi- | tallinity | eter | length | ume | hole | | of fiber | eter | Activity | Activity | Dura- |
| | Types | tution | % | nm | mm | % | μm | Types | Times | mm | value | value | bility |
| Example 1 | Cellulose acetate | 2.92 | 6 | 490 | 4.6 | 78 | 2.6 | Cu | 0.005 | 18 | 3.7 or more | 3.9 or more | 1 |
| Example 2 | Cellulose acetate | 2.11 | 7 | 270 | 3.8 | 85 | 1.7 | Cu | 0.05 | 18 | 3.7 or more | 3.9 or more | 1 |
| Example 3 | Cellulose acetate | 2.87 | 30 | 570 | 3.6 | 71 | 2.5 | Ag | 0.1 | 120 | 3.7 or more | 3.9 or more | 1 |
| Example 4 | Cellulose acetate | 2.66 | 14 | 180 | 1.9 | 70 | 1.4 | Cu | 1 | 18 | 3.7 or more | 3.9 or more | 1 |
| Example 5 | Cellulose acetate | 2.03 | 29 | 740 | 3.5 | 72 | 3.6 | Ag | 0.1 | 120 | 3.5 | 3.2 | 1 |
| Example 6 | Cellulose acetate | 2.47 | 47 | 650 | 3.3 | 76 | 3.0 | Ag | 0.1 | 120 | 3.5 | 3.2 | 2 |
| Example 7 | Cellulose acetate | 1.96 | 31 | 980 | 1.2 | 71 | 5.3 | Ag | 0.1 | 120 | 3.1 | 3 | 2 |
| Example 8 | Deacylated cellulose | 0.04 | 11 | 700 | 1.6 | 75 | 3.3 | Cu | 0.05 | 18 | 3.2 | 3.1 | 2 |
| Example 9 | Cellulose propionate | 2.88 | 23 | 560 | 4.2 | 51 | 2.4 | Cu | 0.005 | 18 | 3.7 or more | 3.7 | 2 |
| Example 10 | Cellulose propionate | 2.72 | 48 | 530 | 2.9 | 51 | 2.2 | Ag | 0.1 | 120 | 3.4 | 3.2 | 2 |
| Example 11 | Cellulose acetate | 2.32 | 18 | 360 | 2.6 | 63 | 2.5 | Cu | 0.01 | 18 | 3.7 or more | 3.8 | 2 |
| Example 12 | Cellulose acetate | 2.26 | 38 | 400 | 2.4 | 63 | 2.3 | Ag | 0.1 | 120 | 3.4 | 3.2 | 2 |
| Example 13 | Cellulose acetate | 2.54 | 17 | 890 | 1.3 | 83 | 5.0 | Cu | 0.05 | 2100 | 3 | 3.1 | 2 |
| Comparative | Cellulose acetate | 2.91 | 7 | 480 | 4.3 | 76 | 2.6 | None | — | — | 0.2 | 0.3 | — |
| Example 1 | | | | | | | | | | | | | |
| Comparative | Cellulose acetate | 2.88 | 55 | 520 | 2.8 | 67 | 2.0 | Cu | 0.01 | 18 | 3.7 or more | 3.9 or more | 4 |
| Example 2 | | | | | | | | | | | | | |
| Comparative | Cellulose acetate | 2.86 | 33 | 1820 | 2.7 | 86 | 7.3 | Ag | 0.1 | 120 | 2.2 | 1.6 | 4 |
| Example 3 | | | | | | | | | | | | | |
| Comparative | Cellulose acetate | 2.55 | 44 | 780 | 0.9 | 80 | 4.0 | Ag | 0.1 | 120 | 2.0 | 1.6 | 4 |
| Example 4 | | | | | | | | | | | | | |
| Comparative | Cellulose nanofiber | 0.01 | 92 | 14 | 0.0012 | 43 | 0.040 | Cu | 0.005 | 18 | 2.8 | 1.9 | 5 |
| Example 5 | | | | | | | | | | | | | |
| Comparative | Cellulose nanofiber | 0.01 | 89 | 11 | 0.0016 | 39 | 0.042 | None | — | — | 0.1 | 0.2 | — |
| Example 6 | | | | | | | | | | | | | |
| Comparative | Polyacrylonitrile | — | 27 | 510 | 2.7 | 66 | 2.8 | Cu | 0.1 | 18 | 3.7 or more | 3.9 or snore | 4 |
| Example 7 | | | | | | | | | | | | | |
| Comparative | Polyacrylonitrile | — | 37 | 460 | 4.2 | 72 | 2.9 | Ag | 0.5 | 120 | 2.6 | 3 | 5 |
| Example 8 | | | | | | | | | | | | | |
| Comparative | Polyvinyl alcohol | — | 18 | 330 | 3.3 | 77 | 2.2 | Cu | 0.05 | 18 | 3.7 or more | 3.9 or more | 4 |
| Example 9 | (cross-linked) | | | | | | | | | | | | |
| Comparative | Polyvinyl alcohol | — | 46 | 770 | 1.3 | 61 | 3.9 | Ag | 0.1 | 120 | 1.9 | 1.8 | 5 |
| Example 10 | (cross-linked) | | | | | | | | | | | | |

Based on the results shown in Table 1, it was found that, in the case where the metal was not carried, the antiviral properties were not exhibited irrespective of the types of cellulose fibers (Comparative Examples 1 and 6).

In addition, in regard to the cellulose fiber, it was found that, in the case in which any one or more of the range of the degree of crystallinity (from 0% to 50%), the range of the average fiber diameter (from 1 nm to 1 μm), and the range of the average fiber length (from 1 mm to 1 m) were deviated from the range, the durability deteriorated, and the antiviral properties also deteriorated (Comparative Examples 2 to 5).

It was found that, in the case where a resin material other than the cellulose fiber was used, in both cases of the hydrophobic material or the hydrophilic material, the durability deteriorated (Comparative Example 7 to 10).

With respect to the above results, it was found that, in the case of using the cellulose fiber that carried the metal and that satisfied the range of the degree of crystallinity (from 0% to 50%), the range of the average fiber diameter (from 1 nm to 1 μm), and the range of the average fiber length (from 1 mm to 1 m) were deviated from the range, the antiviral properties and the durability were improved in all cases (Examples 1 to 13).

Based on the comparison between Examples 3, 5 to 7, and 12, it was found that, in the case where the degree of crystallinity of the cellulose fiber was from 0% to 30%, the durability was further improved.

Based on the comparison between Example 2 and Example 8, it was found that, in the case where the degree of substitution of the cellulose acylate was from 2.00 to 2.95, both the antiviral properties and durability were further improved.

Based on the comparison between Example 1 and Example 9. it was found that, in the case of using the cellulose acetate in which the acyl group in the cellulose acylate was the acetyl group, the durability was further improved.

Based on the comparison between Example 2 and Example 13, it was found that, in the case where the average particle diameter of the metal particles being carried was from 1 nm to 2 μm, both the antiviral properties and the durability were further improved.

What is claimed is:

1. A fiber composite comprising:
a cellulose fiber; and
a metal,
wherein the cellulose fiber contains a cellulose acylate,
at least a part of a surface of the cellulose fiber carries at least a part of the metal,
a degree of crystallinity of the cellulose fiber is from 0% to 50%,
an average fiber diameter of the cellulose fiber is from 1 nm to 1 μm, and an average fiber length of the cellulose fiber is from 1 mm to 1 m.

2. The fiber composite according to claim
wherein the degree of crystallinity of the cellulose fiber is from 0% to 30%.

3. The fiber composite according to claim 1,
wherein a degree of substitution of the cellulose acylate satisfies Formula (1).
2.00<Degree of substitution 2.95 (1)

4. The fiber composite according to claim 1,
wherein an acyl group in the cellulose acylate is an acetyl group.

5. The fiber composite according to claim 2,
wherein an acyl group in the cellulose acylate is an acetyl group.

6. The fiber composite according to claim 3,
wherein an acyl group in the cellulose acylate is an acetyl group.

7. The fiber composite according to claim
wherein a content of the metal is from 0.001 times to 10 times the cellulose fiber on a mass basis.

8. The fiber composite according to claim 1,
wherein the metal is a metal particle.

9. The fiber composite according to claim 8,
wherein an average particle diameter of the metal particle is from 1 nm to 2 μm.

10. The fiber composite according to claim 1,
wherein the metal is at least one selected from the group consisting of silver, copper, zinc, iron, lead, bismuth, and calcium.

11. A porous structure comprising:
the fiber composite according to claim 1.

12. The porous structure according to claim 11,
wherein a void volume is from 30% to 95%.

13. The porous structure according to claim 11,
wherein a through-hole is provided, and
an average hole diameter of the through-hole is from 0.01 μm to 10 μm.

14. A nonwoven fabric comprising:
the fiber composite according to claim 1.
